(19) United States
(12) Patent Application Publication
(10) Pub. No.: US 2008/0203819 A1
(43) Pub. Date: Aug. 28, 2008

(54) Energy Storage Device of a Transformer

(76) Inventor: Yu-Wen Cho, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/767,476

(22) Filed: Jun. 23, 2007

(30) Foreign Application Priority Data
Feb. 26, 2007 (TW) 096106556

(51) Int. Cl. H02J 9/00

(52) U.S. Cl. 307/64

(57) ABSTRACT

An energy storage device of a transformer includes a first node formed on a side of a primary end of the transformer, a second node formed on another side of the primary end, a third node, a resistor coupled between the first node and the third node, a diode coupled between the first node and the third node, a first capacitor coupled between the second node and the third node, and a clamping unit coupled between the second node and the third node, for clamping voltage of the first capacitor.

### BACKGROUND OF THE INVENTION

1. Field of the Invention

The present invention provides an energy storage device of a transformer, and more particularly, an energy storage device capable of prolonging powering function of an electronic device when power disconnection occurs.

2. Description of the Prior Art

Electronic devices usually comprise power supply devices for providing operating DC (direct-current) power, which can be linear power supplies, isolating switch power supplies (SPS), etc. A linear power supply is composed of a transformer, a rectifier, and a voltage stabilization circuit, and has advantages of simple structure, high stability, high reliability, little ripples, low EMI (electromagnetic interference). However, the linear power supply uses the transformer with large current, and is too large and heavy to be settled on a printed circuit board. In addition, the transformation efficiency of the linear power supply is too low to satisfy DC input applications. Therefore, the prior art develops the isolating SPS to overcome defects of the linear power supply.

The isolating SPS separates a primary side with high voltage and a secondary side with low voltage by isolating a transformer, and transforms high-voltage (ex. 220V) AC (alternating-current) power into low-voltage (ex. 5V) DC power with a PWM (pulse width modulator) controller. In addition to advantages of the linear power supply, the isolating SPS has advantages of high transformation efficiency, isolation between input and output ends, and protection of over voltage or current. Also, the isolating SPS can be applied for DC input applications, and can be installed on a printed circuit board.

Please refer to FIG. 1, which illustrates a schematic diagram of a prior art isolating SPS 10. The isolating SPS 10 transforms AC power provided by an AC power source 116 into DC current for a load 114 of an electronic device. The isolating SPS 10 includes a bridge rectifier 100, a capacitor 102, a transformer 104, a voltage stabilization circuit 106, and a feedback circuit 108. The bridge rectifier 100 transforms AC power provided by the AC power 116 into DC power for the capacitor 102 to store energy and perform rectification operations. The transformer 104 includes a primary end 110 and a secondary end 112. The secondary end 112 can sense current variation of the primary end 110, and generate corresponding DC voltage. The voltage stabilization circuit 106 stabilizes DC power outputted from the secondary end 112 of the transformer 104, so as to reduce ripples. The feedback circuit 108 adjusts operations of the bridge rectifier 100 according to feedback signals of the secondary end 112.

Through the isolating SPS 10, stable DC power is provided. However, the isolating SPS 10 may cause transient power disconnection and make the electronic device failure. For example, please refer to FIG. 2. In FIG. 2, multi-socket power adapters 200 and 202 include breakers 204 and 206 for automatically cutting power off under short-circuit or overload situations, so as to protect electronic devices. However, after short circuit occurs, but before the breakers work, there is a short duration (0.5 to few seconds) without any power supply. In such circumstance, the electronic devices may meet serious problems, such as data lost due to PC reset, snowflakes on TV screens, etc.

To prolong power supply time of the SPS during power disconnection, capacitance of the capacitor 102 must be increased. To satisfy 240V AC power applications, the capacitor 102 must be capable of supporting 400V peak value voltage. As a result, the cost of production will be increased, and the capacitor 102 will be larger.

### SUMMARY OF THE INVENTION

It is therefore a primary objective of the claimed invention to provide an energy storage device of a transformer.

According to the claimed invention, an energy storage device of a transformer comprises a first node formed on a side of a primary end of the transformer, a second node formed on another side of the primary end, a third node, a resistor coupled between the first node and the third node, a diode coupled between the first node and the third node, a first capacitor coupled between the second node and the third node, and a clamping unit coupled between the second node and the third node, for clamping voltage of the first capacitor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a prior art isolating switch power supply.

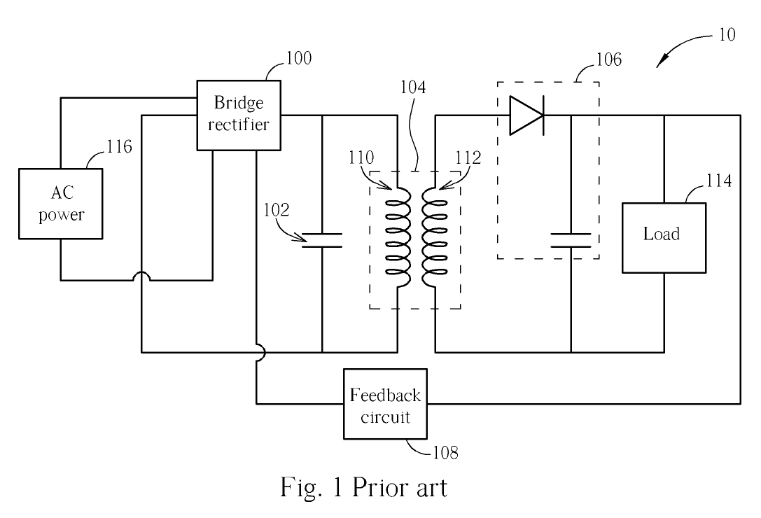

FIG. 2 illustrates a schematic diagram of a power system having multi-socket power adapters.

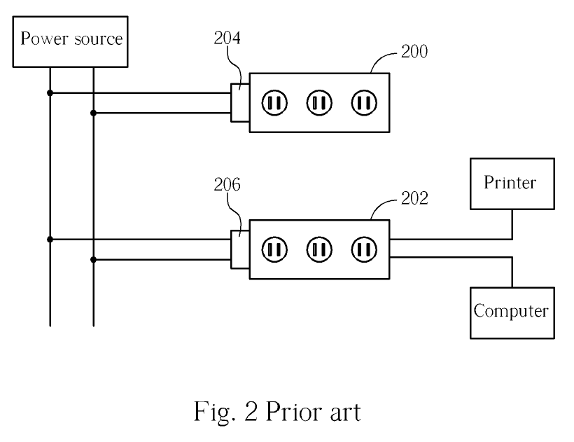

FIG. 3 illustrates a schematic diagram of a power supply in accordance with an embodiment of the present invention.

FIG. 4 illustrates a schematic diagram of an energy storage device in accordance with an embodiment of the present invention.

### DETAILED DESCRIPTION

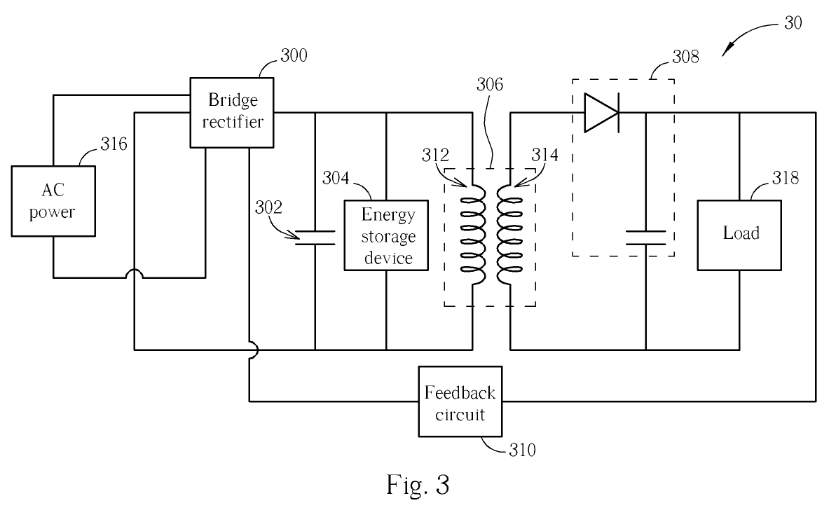

Please refer to FIG. 3, which illustrates a schematic diagram of a power supply 30 in accordance with an embodiment of the present invention. The power supply 30 can protect electronic devices, and includes a bridge rectifier 300, a capacitor 302, an energy storage device 304, a transformer 306, a voltage stabilization circuit 308, and a feedback circuit 310. The transformer 306 includes a primary end 312 and a secondary end 314 for transforming power for a load 318 of an electronic device. The bridge rectifier 300 transforms AC power provided by an AC power generator 316 into DC power for the primary end 312. The energy storage device 304 is coupled to two ends of the primary end 312, and utilized for storing backup power. The voltage stabilization circuit 308 includes a diode and a capacitor between two ends of the secondary end 314, and is utilized for stabilizing DC power provided by the secondary end 314 of the transformer 306, so as to reduce ripples. The feedback circuit 310 adjusts operations of the bridge rectifier 300 according to feedback signals of the secondary end 314. Detailed Operations of the power supply 30 are as follow.

In normal cases, the bridge rectifier 300 transforms AC power provided by the AC power generator 316 into DC power for the capacitor 302, the energy storage device 304, and the primary end 312 of the transformer 306. The secondary end 314 of the transformer 306 can sense current variation of the primary end 312, and generate corresponding DC voltage for the voltage stabilization circuit 308 for providing stable DC power for the load 318. In addition, the feedback circuit 310 adjusts operations of the bridge rectifier 300 according to feedback signals of the secondary end 314, so as to adjust DC power provided by the secondary end 314.

When transient power disconnection occurs between the AC power generator 316 and the power supply 30, the present invention can protect the electronic devices with the energy storage device 304. As AC power is disconnected, the power supply 30 is under a non-power state, the energy storage device 304 starts providing power for the load 318, so as to keep driving the electronic device, or to send out an alarm for the electronic device. Therefore, the present invention can protect the electronic device.

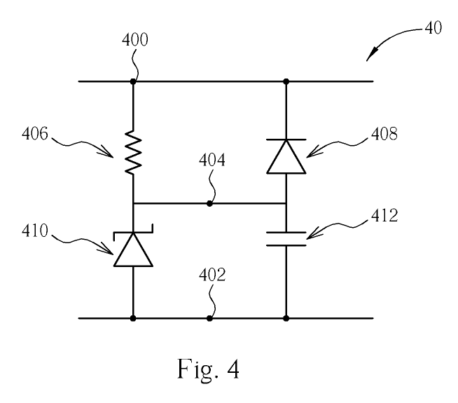

The energy storage device 304 can be any circuit capable of providing stored energy for a predetermined duration. For example, please refer to FIG. 4, which illustrates a schematic diagram of an energy storage device 40 in accordance with an embodiment of the present invention. The energy storage device 40 is utilized for realizing the energy storage device 304, and includes a resistor 406, a diode 408, a capacitor 412, and a clamping unit 410. The resistor 406 and the diode 408 are in parallel connection between a first node 400 and a third node 404, and the capacitor 412 and the clamping unit 410 are in parallel connection between a second node 402 and the third node 404. The first node 400 is formed on a side of the primary end 312, while the second node 402 is formed on another side of the primary end 312. The clamping unit 410, preferably a Zener diode, is utilized for restricting cross voltage of the first capacitor 412. Operations of the energy storage device 40 are as follows.

Normally, DC power outputted from the bridge rectifier 300 charges the capacitor 412 through the resistor 406. The clamping unit 410 restricts cross voltage of the capacitor 412, so that capacitance of the capacitor 412 can be increased, and discharge time of the energy storage device 40 can be prolonged. As power disconnection occurs, the capacitor 412 starts providing stored electricity for the primary end 312 of the transformer 306 through the diode 408, and the secondary end 314 generates corresponding DC voltage for the load 318. Therefore, the present invention can protect the electronic device with the energy storage device 40.

In summary, the clamping unit 410 of the energy storage device 40 restricts cross voltage of the capacitor 412, so that capacitance of the capacitor 412 can be increased, and discharge time of the energy storage device 40 can be prolonged. As a result, if power disconnection occurs, the present invention can prevent the electronic device from suffering serious problems, such as data lost due to PC reset, snowflakes on TV screens, etc. Therefore, the present invention can effectively protect electronic devices.

Those skilled in the art will readily observe that numerous modifications and alterations of the device and method may be made while retaining the teachings of the invention.

What is claimed is:

1. An energy storage device of a transformer comprising:
a first node formed on a side of a primary end of the transformer;
a second node formed on another side of the primary end;
a third node;
a resistor coupled between the first node and the third node;
a diode coupled between the first node and the third node;
a first capacitor coupled between the second node and the third node; and
a clamping unit coupled between the second node and the third node, for clamping voltage of the first capacitor.

2. The energy storage device of claim 1, wherein the clamping unit is a Zener diode.
